(19) United States
(12) Patent Application Publication
(10) Pub. No.: US 2005/0055808 A1
(43) Pub. Date: Mar. 17, 2005

(54) Metallic fastener having positioning device

(76) Inventor: Jien Wei Huang, Chuang Hua (TW)

Correspondence Address: Jien Wei Huang, P.O. Box 63-298, Taichung, 406, TW

(21) Appl. No.: 10/402,782

(22) Filed: Mar. 28, 2003

(51) Int. Cl. B42F 1/00

(52) U.S. Cl. 24/67 R

(57) ABSTRACT

A metallic fastener includes a head, two bent segments bent from two opposite sides of the head and engaged onto and parallel to the head, two shanks bent and extended from the bent segments, and a cap attached onto the head. The head further includes one or more projections extended beyond the bent segments of the head, and/or includes one or more bent flaps to position the heads of the metallic fasteners in a guide track, and to guide the metallic fasteners to move through the guide track, and to prevent the metallic fasteners from being jammed or engaged with each other within the guide channel of the guide track.

### BACKGROUND OF THE INVENTION

1. Field of the Invention

The present invention relates to a metallic fastener, and more particularly to a metallic fastener having a protecting cap, and having one or more positioning devices for facilitating the manufacturing of the metallic fastener.

2. Description of the Prior Art

Various kinds of typical metallic fasteners have been developed and comprise a rounded head, and two prongs or shanks extended from the rounded head, for engaging through document or sheet materials, and in order to bind or fasten the document or sheet materials together.

For example, U.S. Pat. No. 512,621 to McGill discloses one of the typical metallic fasteners comprising a rounded head. However, the rounded head of the typical metallic fasteners prevent the typical metallic fasteners from being disposed up side down, such that the typical metallic fasteners may not be easily guided to move through guide tracks, and such that the typical metallic fasteners may not be easily manufactured with automatic machines or the like. The typical metallic fasteners may only be manufactured manually.

U.S. Pat. No. 308,368 to McGill discloses another typical metallic fastener comprising a flat circular head. However, the flat circular head of the typical metallic fasteners have no suitable guiding members or devices to guide the fasteners to move through guide tracks, and such that the typical metallic fasteners also may not be easily manufactured with automatic machines or the like. The typical metallic fasteners also may only be manufactured manually.

The present invention has arisen to mitigate and/or obviate the afore-described disadvantages of the conventional metallic fasteners.

### SUMMARY OF THE INVENTION

The primary objective of the present invention is to provide a metallic fastener including a protecting cap for engaging onto and for protecting the central circular head, and for preventing the head from being rusted.

The other objective of the present invention is to provide a metallic fastener including one or more positioning devices for positioning or guiding the metallic fasteners to move relative to the guide track, and for preventing the metallic fasteners from being jammed or engaged with each other within the guide track, and thus for facilitating the manufacturing of the metallic fastener.

In accordance with one aspect of the invention, there is provided a metallic fastener comprising a head including two opposite first sides and two opposite second sides, two bent segments bent from the opposite first sides of the head and engaged onto and parallel to the head, two shanks bent and extended from the bent segments respectively, a cap attached onto the head. The head further includes at least one projection extended therefrom and extended beyond the bent segments of the head, for positioning the heads of the metallic fasteners and for guiding the metallic fasteners to move relative to a guide track of a machine, to prevent the metallic fasteners from being jammed or engaged with each other within a guide channel of the guide track. The metallic fasteners may thus be smoothly guided to move through the channel of the guide track, and thus may be easily manufactured automatically by automatic machines or the like, such that the configuration of the metallic fasteners is excellent for mass production purposes.

The head further includes two flaps bent from the opposite second sides of the head and separated from the bent segments of the head.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a metallic fastener in accordance with the present invention;

FIG. 2 is a cross sectional view of the metallic fastener, taken along lines 2-2 of FIG. 1;

FIG. 3 is an exploded view of the metallic fastener;

FIG. 4 is an enlarged partial perspective view of the metallic fastener, before the protective cap is attached onto the head of the metallic fastener;

FIG. 5 is a cross sectional view similar to FIG. 2. illustrating the operation of the metallic fastener;

FIG. 6 is a cross sectional view taken along lines 6-6 of FIG. 7, illustrating the manufacturing operation of the metallic fastener through a guide track; and

FIG. 7 is a cross sectional view taken along lines 7-7 of FIG. 6.

### DETAILED DESCRIPTION OF THE PREFERRED EMBODIMENT

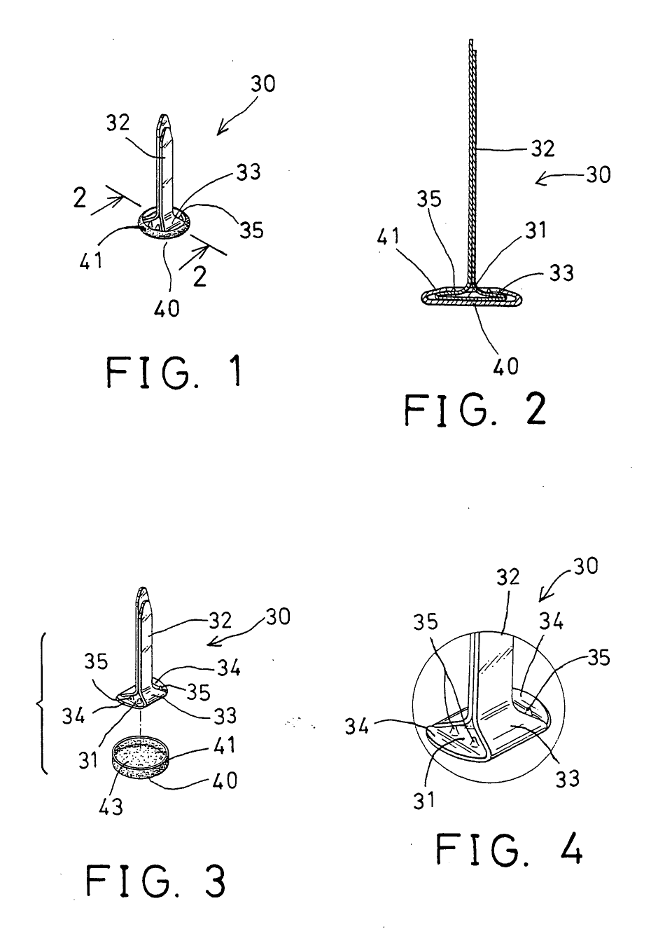

Referring to the drawings, and initially to FIGS. 1-4, a metallic fastener 30 in accordance with the present invention comprises a head 31 having a substantially circular structure and having a planar or flat structure, and two prongs or shanks 32 extended or bent from two opposite first sides of the head 31, and two bent segments 33 coupled between the head 31 and the shanks 32.

For example, the bent segments 33 are bent from the head 31 and forced onto or engaged onto the head 31, and substantially parallel to the head 31, best shown in FIG. 2. The shanks 32 are bent from the bent segments 33 and are substantially perpendicular to the head 31 and the bent segments 33 respectively. It is preferable that the bent segments 33 include a width smaller than that of the head 31, but greater than that of the shanks 32, for increasing the coupling strength between the head 31 and the shanks 32.

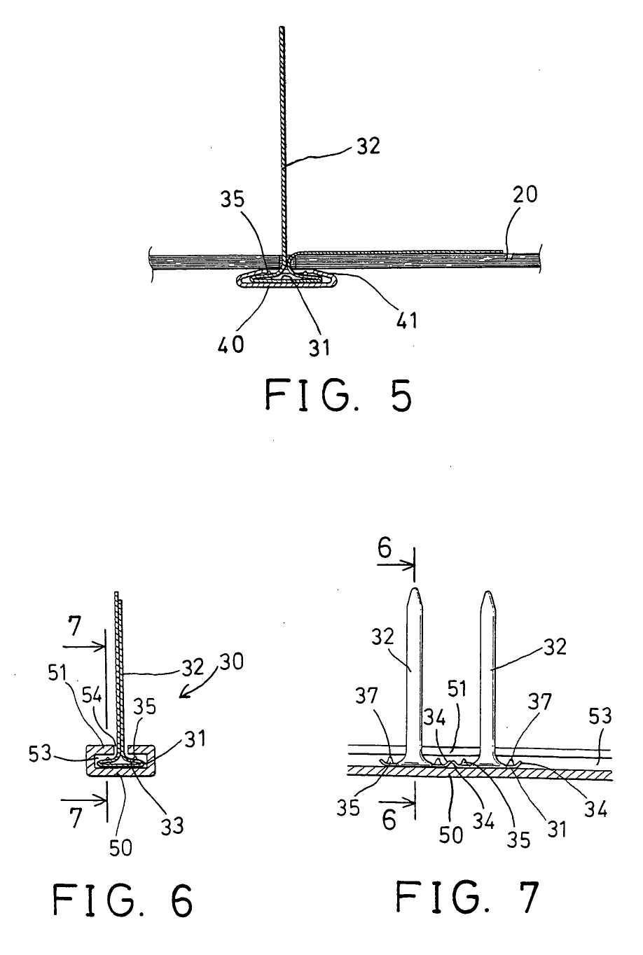

It is preferable that the shanks 32 are superimposed or contiguous and of unequal length, so that one of the shanks 32 projects slightly beyond the other shank 32 to facilitate their separation for the purpose of flattening them down upon the articles or objects or sheet materials 20 (FIG. 5) to which the metallic fastener 30 is to be applied.

The metallic fastener 30 further includes a protective cap 40 having a peripheral wall 41 extended from the outer peripheral portion thereof to form or define a space 43 therein, and to receive the head 31 of the metallic fastener 30 therein. The peripheral wall 41 of the protective cap 40 may then be bent and forced onto or engaged onto the outer peripheral portion of the head 31. It is preferable that the protective cap 40 is made or plastic or synthetic materials, to protect the head from being rusted.

The formation and the provision of the protective cap 40 onto the head 31 of the metallic fastener 30, and the formation and the provision of the shanks 32 relative to the head 31 are typical and will not be described in further details.

As shown in FIGS. 3-4, and 6-7, the head 31 of the metallic fastener 30 further include two flaps 34 slightly bent or inclined relative to the head 31, and located on the other or the second opposite sides of the head 31, and offset or separated from the bent segments 33 and the shanks 32. The head 31 of the metallic fastener 30 further include one or more projections 35 extended therefrom and extended higher beyond the bent segments 33, best shown in FIGS. 2, 5, 6.

As shown in FIGS. 6 and 7, while manufacturing the metallic fasteners 30 or before attaching the protective cap 40 onto the head 31 of the metallic fastener 30, the metallic fastener 30 will be aligned and guided to move through a guide track 50 by such as shaking or vibrating machines (not shown).

The guide track 50 includes a channel 53 formed therein and defined by a pair of opposite flanges 51 to slidably receive the head 31 of the metallic fastener 30, and includes a groove 54 formed or defined between the pair of opposite flanges 51, to slidably receive the shanks 32 of the metallic fasteners 30.

As best shown in FIG. 7, the bent flaps 34 from the heads 31 of the metallic fasteners 30 may be engaged with each other while the metallic fasteners 30 are aligned and guided to move through the guide track 50, to prevent the heads 31 of the metallic fasteners 30 from being jammed or engaged with each other within the channel 53 of the guide track 50, and thus for allowing the metallic fasteners 30 to be smoothly moved through the channel 53 of the guide track 50.

The projections 35 extended from the head 31 of the metallic fastener 30 are extended higher beyond the bent segments 33, and extended toward the flanges 51 of the guide track 50, or include a tip 37 arranged to be located close to the flanges 51 of the guide track 50, in order to further smoothly guide the metallic fasteners 30 to move through the channel 53 of the guide track 50, and so as to further prevent the heads 31 of the metallic fasteners 30 from being jammed or engaged with each other within the channel 53 of the guide track 50.

The bent flaps 34 and/or the projections 35 of the heads 31 of the metallic fasteners 30 may thus be formed or used as the positioning devices to position or guide the metallic fasteners 30 to move relative to the guide track 50, and to prevent the metallic fasteners 30 from being jammed or engaged with each other within the channel 53 of the guide track 50.

The metallic fasteners 30 may thus be smoothly guided to move through the channel 53 of the guide track 50, and thus may be easily manufactured automatically by automatic machines or the like, such that the configuration of the metallic fasteners is excellent for mass production purposes.

Accordingly, the metallic fastener in accordance with the present invention includes a protecting cap for engaging onto and for protecting the central circular head, and for preventing the head from being rusted, and includes one or more positioning devices for positioning or guiding the metallic fasteners to move relative to the guide track, and for preventing the metallic fasteners from being jammed or engaged with each other within the guide track, and thus for facilitating the manufacturing of the metallic fastener.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1-4. (canceled).

5. A metallic fastener comprising:
a head including two opposite first sides and two opposite second sides,
two bent segments bent from said opposite first sides of said head and engaged onto and parallel to said head,
two shanks bent and extended from said bent segments respectively,
two flaps bent from said opposite second sides of said head and separated from said bent segments of said head, and
said head including at least one projection extended therefrom and extended beyond said bent segments of said head.
